(19) United States
(12) Patent Application Publication
(10) Pub. No.: US 2006/0046724 A1
(43) Pub. Date: Mar. 2, 2006

(54) Soft handoff management

(76) Inventors: Bobby That Dao Ton, Lachine (CA); Lev Deich, Montreal (CA); Anupma Grover, La Prairie (CA)

Correspondence Address: SANDRA BEAUCHESNE;Ericsson Canada Ins., Patent Department (LMC/M/P), 8400 Decarie Blvd., Town Mount Royal, QC, H4P 2N2, CA

(21) Appl. No.: 10/929,460

(22) Filed: Aug. 31, 2004

(51) Int. Cl. H04Q 7/20

(52) U.S. Cl. 455/442; 455/439

(57) ABSTRACT

The invention is a method for performing a soft handoff of a mobile terminal (MT) from a source (BSC) to a target BSC in a telecommunication network. The method further detects a failure at one of the target BSC and the source BSC that handle a call for the MT. Responsive to the detection, the method sends a reset message from one of the target BSC and the source BSC to one of the source BSC and the target BSC. The reset message includes a Source ID for identifying the failed source process if the failure is detected at the source BSC and a Target ID for identifying the failed target process if the failure is detected at the source BSC. Afterwards, the method uses one of the Source ID or the Target ID for tearing down the call at one of the target BSC and the source BSC.

### BACKGROUND OF THE INVENTION

1. Field of the Invention

The invention relates to a method for optimizing handoff procedures in a cellular telecommunication network.

2. Description of the Related Art

As of today, a mobile terminal (MT) may roam in a telecommunication network during a call. The MT may roam from its home network to a foreign network and this depending on agreements between different service providers. For doing so, the MT is handed off following network operations in the telecommunication network. For instance, a mobile switching center (MSC) could perform the network operations or alternatively the handoff may be performed between a source base station controller (BSC) and a target BSC.

A BSC is the control part of a radio base station (RBS). The BS is central radio transmitter/receiver that maintains communications with the MT. The BS usually covers a given range (typically a cell) for MTs. The BSC controls one or more BSs radio signals, thus reducing the load on the MSC. The BSC also performs radio signal management functions for BSs and manages functions such as frequency assignment and handoff.

As defined in interim standard (IS), Interoperability Specifications (IOS) for CDMA2000 Access Network Interfaces, TIA/EIA/IS-2001-A published in 2000 by the TIA/EIA, which is included herewith by reference, a source BSC hands off a MT during a call to a target BSC and this when detecting that the signal strength with the MT is below a certain threshold. The source BSC further informs the associated serving MSC of the new location of the MT. Next, the source BSC establishes a path with a target BSC for handing off the MT. This type of hand off is called inter-BSC soft handoff of the MT. Inter-BSC soft handoff includes the capability of the BSC to act as both the ‘source’ and the ‘target’ in a soft handoff. As a ‘source’, the BSC is responsible for initiating and maintaining a radio link between the MT that is being served by the BSC and a BS that is within another BSC. As a ‘target’, the BSC is responsible for providing a radio link between a BS within a source BSC, and a MT that is being served by another BSC (target BSC). Inter-BSC soft handoff functionality is supported by the A3 and A7 interfaces to the BSC.

The A3 interface is composed of signaling and traffic channels. It provides an ability to establish and remove A3 traffic connections. The A3 interface also provides support for operational procedures, such as turning on/off voice privacy or changing the service configuration of a call. The A7 interface provides direct BSC to BSC signaling for the support of an efficient soft handoff procedure. Only a call release procedure can interrupt a handoff procedure.

The current A7 interface does not support multiple instances of endpoints. Therefore, the source BSC has a single instance of the soft handoff functionality running on the ‘target’ BSC. When calls are handed off from the source BSC to the target BSC, the source BSC allocates a board for each call on its side and the same thing is applied at the target BSC side for handing off MTs and further calls from the MTs. More than one call can be allocated to a board in the target BSC or in the source BSC. A hardware or software failure at the source or the target BSC results in complete dropped handoffs calls and the inability to process new requests. Furthermore, the capacity for handling calls is limited to the resources of the hardware running the software, which is not scalable. A solution to that problem of limited resources is to perform a load distribution of calls within the source BSC or the target BSC.

However, if a failure occurs it cannot be possible to remove the soft handoff calls on the source BSC, since it cannot be possible to identify which calls were associated to failed instance of a software running on the source BSC or the target BSC. Therefore, this results in dropping all soft handoffs calls at the source BSC or the target BSC during hardware of software failure that occurs at the same source BSC or target BSC. A solution to this problem could be a static load distribution. However, this causes inefficient use of resources.

Another impact of load distribution is the handling of requests associated to soft handoff calls. Without such a mechanism, such requests will be difficult to handle and waste resources defeating the purpose of load distribution. Therefore, there is a need to improve the ability of a BSC to support soft handoff for a MT, between base-stations located within different BSCs. The invention provides a solution to that problem.

### SUMMARY OF THE INVENTION

It is therefore one broad object of this invention to provide a method for performing a soft handoff of a mobile terminal (MT) from a source base station controller (BSC) to a target BSC in a telecommunication network, the method comprising steps of:

sending from the source BSC to the target BSC a request for handing off the MT to the target BSC, the request including a source process identifier (Source ID) for identifying a source process that handles a call for the MT in the source BSC;

assigning a target process at the target BSC for handling the call;

storing at the target BSC the Source ID and a target process identifier (Target ID), wherein the Target ID identifies the target process that handles the call for the MT in the target BSC;

sending from the target BSC to the source BSC a handoff response, the handoff response including the Target ID;

detecting a failure at one of the target BSC and the source BSC;

responsive to the detection, sending a reset message from one of the target BSC and the source BSC to one of the source BSC and the target BSC, the reset message including the Target ID if the failure is detected at the target BSC and the Source ID if the failure is detected at the source BSC; and

using one of the Source ID or the Target ID of the reset message for tearing down the call at one of the target BSC and the source BSC.

It is therefore another broad object of his invention to provide a target base station controller (BSC) for handing off a mobile terminal (MT) in a telecommunication network, the BSC comprises:

a service logic for:
receiving a request message from a source BSC for handing off the MT, the request message including a source process identifier (Source ID) for identifying a source process that handles a call for the MT in the source BSC;
assigning at the target BSC at least one target process for handling the call, wherein the at least one target process comprises a memory for storing the Source ID and a target process identifier (Target ID) for identifying the at least one target process that handles the call for the MT in the target BSC; and

wherein the service logic detects a failure at the target BSC and sends to the source BSC a reset message including the Target ID for tearing down the call associated with the at the source BSC.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is illustrating a telecommunication network in which a mobile terminal (MT) is handed off from a source base station controller (BSC) to a target BSC in accordance to the invention;

FIG. 2 is a nodal operation and signal flow diagram illustrating a flow of messages of a method for handing off a mobile terminal (MT) during a call from a source BSC to a target BSC in accordance to the invention;

FIG. 3a is a flow chart showing a method for tearing down a call if a failure occurs at a source BSC in accordance to the invention; and

FIG. 3b is a flow chart showing a method for tearing down a call if a failure occurs at a target BSC in accordance to the invention.

### DETAILED DESCRIPTION OF THE PREFERRED EMBODIMENTS

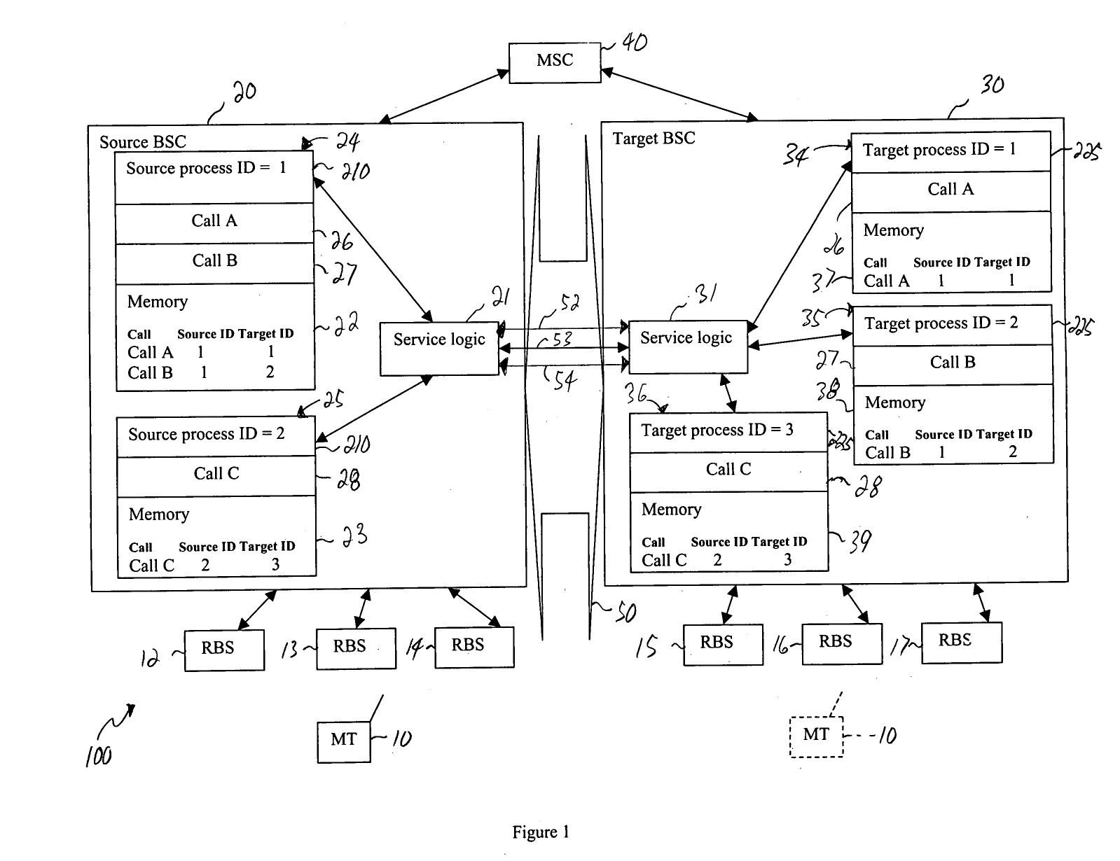

Reference is now made to FIG. 1, which illustrates a telecommunication network 100 in which a mobile terminal (MT) is handed off from a source base station controller (BSC) 20 to a target BSC 30 in accordance to the invention. For instance, the cellular telecommunication network 100 may be a third generation network (3G) such as a CDMA2000 network or any other packet data network. The cellular telecommunications network 100 comprises a mobile switching center (MSC) 40 for serving the MT 10 and for providing switching capabilities between BSCs. The MSC 40 serves at least one BSC and is not limited to the number of BSCs shown in FIG. 1.

The telecommunication network 100 also comprises other network elements defined in IS-2001 and which are omitted in FIG. 1 for clarity purposes. It can also be understood that a handoff procedure, as defined in IS-2001, allows a source BSC 20 to become a target BSC and the target BSC 30 to become a source BSC. However, a source BSC may simultaneously act as a target BSC for different MTs and vice versa.

BSC 20 and BSC 30 each serve at least one radio base station (RBS). In FIG. 1, the BSC 20 serves RBSs 12, 13 and 14 and the BSC 30 serves RBSs 15, 16 and 17. Each RBS covers a cell (not shown) for providing radio services to the MT 10. The source BSC and therefore the target BSC 30 comprises at least one service logic 21 and service logic 31 for receiving, processing and sending messages in the telecommunication network 100.

The service logic 21 and the service logic 31 provide load balancing and soft handoff processing of calls for MTs that are served by BSC 20 and BSC 30 in the telecommunication network 100. A service logic can be a software, a hardware or any combination thereof.

A BSC comprises at least one process for handling calls for MTs and which is a piece of hardware such as a physical electronic board, a software or a combination thereof. In particular, a process of a source BSC is a source process and a process in a target BSC becomes a target process and this depending on the role of a BSC. Each process has a unique identifier in each a BSC.

In FIG. 1, the source BSC 20 comprises source process 24 and source process 25 while the target BSC 30 comprises target process 34, target process 35 and target process 36. Each source process and each target process further comprises a memory for storing information related to calls. The information may be endpoints for a call. The endpoints consist of a source process identifier (Source ID) for identifying a source process and a target process identifier (Target ID) for identifying a target process that handle a call for a MT. The source process 24 comprises a memory 22 and the source process 25 comprises a memory 23. On the other hand, at the target BSC 30, the target process 34 comprises a memory 37, the target process 38 comprises a memory 32 and the target process 36 comprises a memory 39.

It can be understood that a source process and a target process can handle more than one call. For instance, call 26 (call A) and call 27 (call B) are both handled by source process 24 at the source BSC 20 and are handed off to the target BSC 30 and more particularly the target process 34 and the target process 35. Another example is call 28 (call C), which is handled with source process 25 and which is handed off to target process 36.

Whenever, the MT 10 roams outside the cells covered by RBSs 12, 13 or 14 during a call, the service logic 21 detects that the signal strength between one of the RBS 12, 13 or 14 is decreasing and hands off the MT 10 to a neighbored RBS which can be any of the RBSs 15, 16 and 18 therefore the BSC 20 hands off the MT 10 to the BSC 30. For instance, the MT 10 may be involved in call 26 (call A). The BSC 20 then communicates with the BSC 30 via an A7 interface 50 for establishing a path for call 26 and for sending/receiving messages.

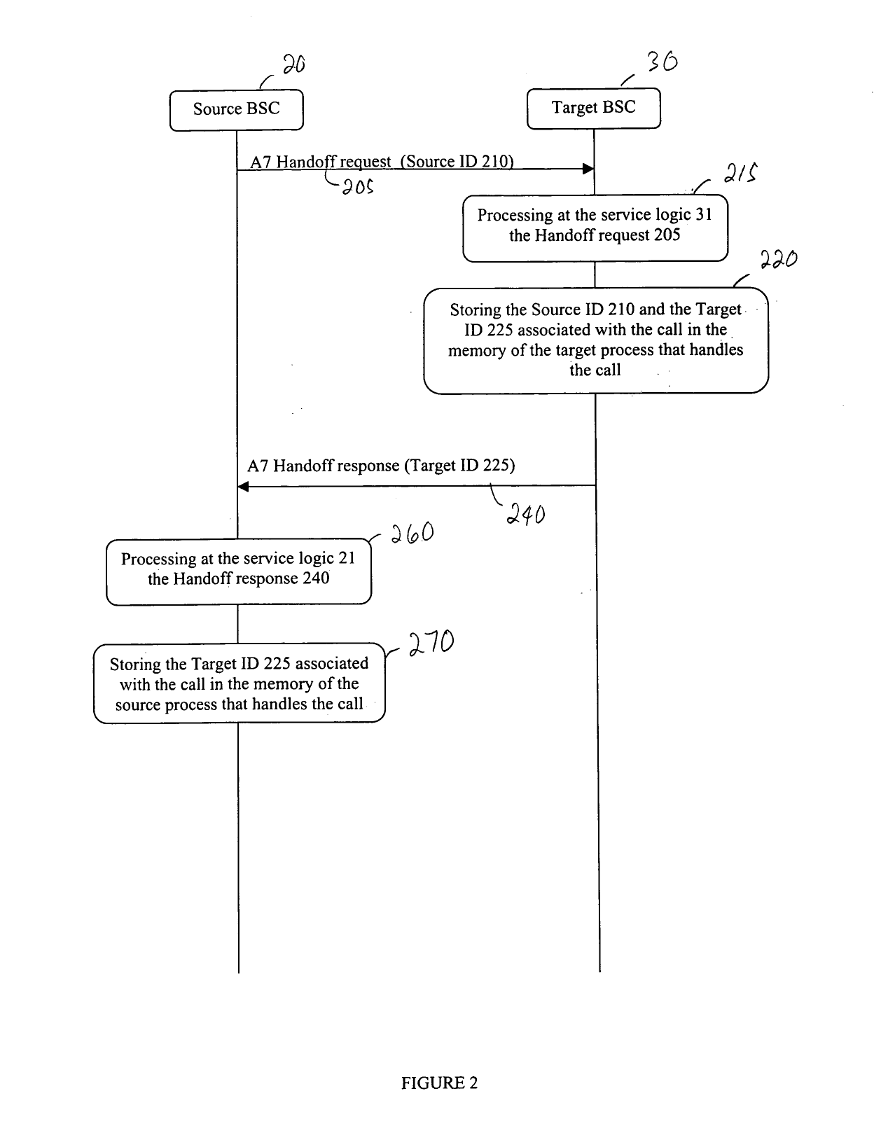

Reference is now made to FIG. 2, which is a nodal operation and signal flow diagram that illustrates a flow of messages of a method for handing off the MT 10 during call 26 from the source BSC 20 to a target BSC 30 in accordance to the invention. In FIG. 2, the source BSC 20 sends an A7 Handoff request message 205 to the target BSC 30. The A7 Handoff request message 205 includes a source process identifier 210 (Source ID 210=1) that identifies source process 24, which handles the call 26 at the source BSC 20 for the MT 10. The source process 24 has been previously assigned by the service logic 21 using a load balancing algorithm. At step 215, the target BSC 30 processes the A7 Handoff request message 205. The service logic 31 uses a load balancing algorithm for assigning a target process 34 for call 26. Then, the target process 34 stores in the memory 37 the Source ID 210 and a target process identifier 225 (Target ID 225=1) for identifying the target process 34 to which call 26 has been assigned for handling the call (step 220). Following this the target BSC 30 sends via the service logic 31 to the source BSC 20 an A7 Handoff response 240 including the Target ID 225. Then, a path 52 for call 26 is considered to be established when the Target ID 225 is received at the source BSC 20. The path 52 is established on the A7 interface 50 and the source BSC 20 and the target BSC 30 may exchange further A7 messages related to call 26 via the established path 52.

In a distributed architecture, a source and a target BSCs may have several paths on an A7 interface if they have distributed process handling. As a consequence, each call may have its associated path. Any request associated to the same call must specify its path or its endpoints (Source ID and Target ID) in an A7 message. For example, path 53 is established for call 27 and path 54 for call 28. Calls 27 and 28 involve other MTs (not shown) in the telecommunication network 100.

Alternatively, the Source ID 210 and Target ID 225 can be inserted in a field of an A7 Originating identifier (A7 Originating ID) (not shown) or an A7 Destination identifier (A7 Destination ID) (not shown). The A7 Originating ID may be further sent from the target BSC 30 to the source BSC 20 and the Destination ID may be further sent from the source BSC 20 to the target BSC 30.

At step 260, the service logic 21 at the source BSC 20 processes the A7 Handoff response message 240 and stores in the memory 22 the Source ID 210 and Target ID 225 associated with call 26 (step 270). The source BSC 20 further includes the Source ID 210 in any subsequent A7 messages that needs to be sent to the target BSC 30. On the other hand, the target BSC 30 includes the Target ID 225 in any subsequent A7 messages related to the same call 26 that needs to be sent to the source BSC 20.

Advantageously, all subsequent messages for the same call 26 or for any call handled by the source BSC 20 or the target BSC 30 must contain a Source ID or a Target ID so they can be routed to the process that handles the call. This includes any future A7 message for an already established call with an established path. This is done in a way to allow the target process and the source process to handle all requests messages for the same call. Consequently, sending the Source ID 210 to the target BSC 30 and the Target ID 225 to the source BSC 20 increases the capacity of both BSCs (number of soft handoff calls) and set-up rate and minimize the number of lost soft handoff during a hardware or software failure.

A failure may happen at one of the source BSC 20 or the target BSC 30 for any reason such as software or hardware failure affecting a target process or a source process. Consequently, in case of a failure, all calls associated with a failed path can be dropped without affecting other calls that are set up on other paths. For instance, if a failure occurs at the target process 34, only calls handled by target process 34 need to be dropped.

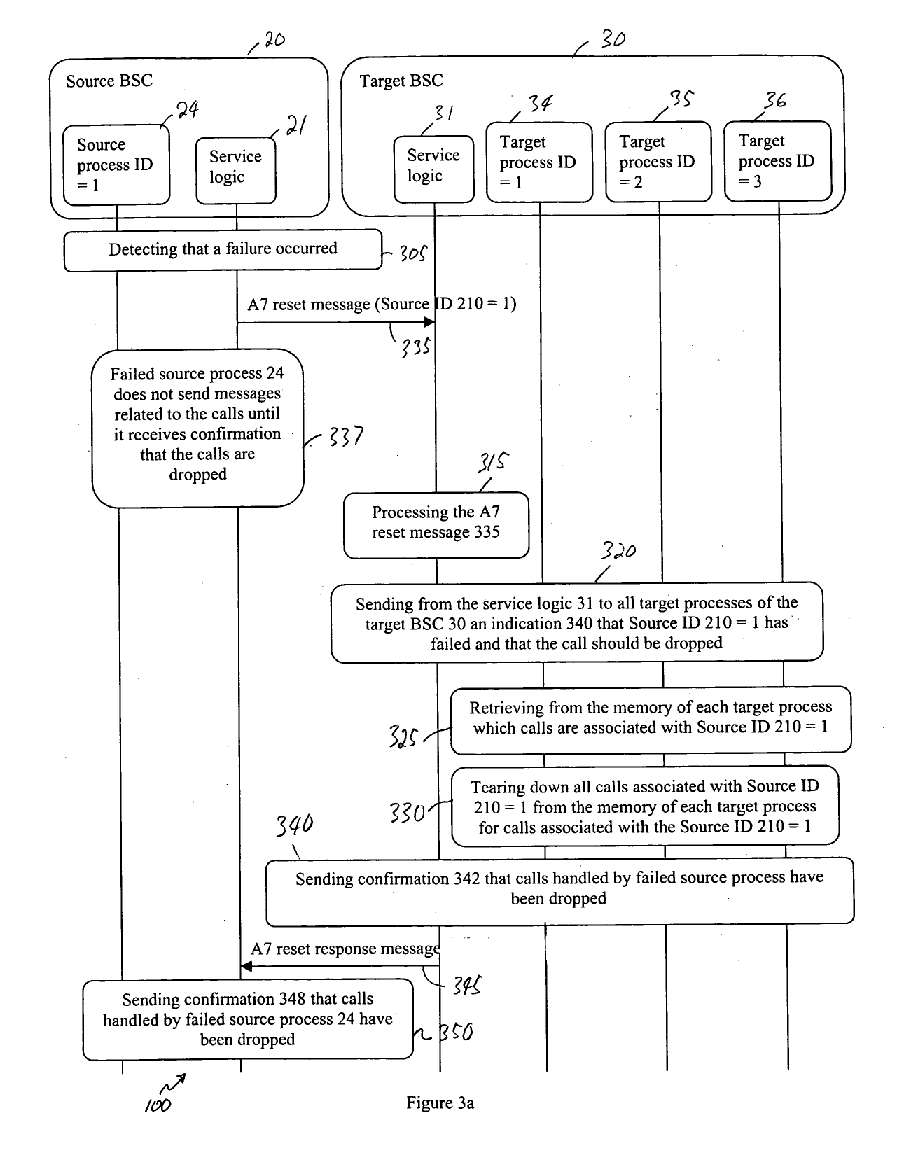

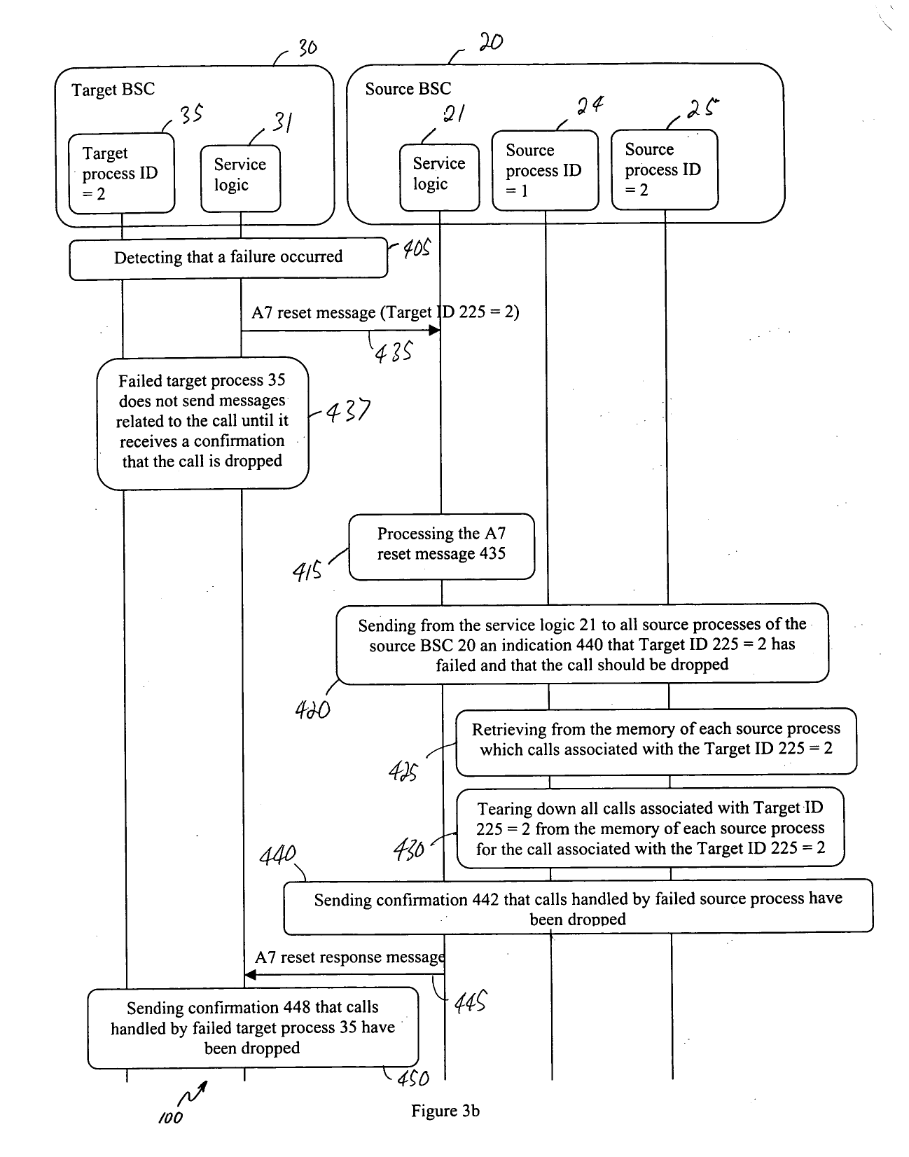

In particular, if a failure occurs at one of the processes handling calls either on a source or target BSC, a message such as an A7 Reset message can be sent to a remote BSC for tearing down calls associated to a path. Reference is now made to FIG. 3a, which is a flow chart showing a method for tearing down a call if a failure occurs at the source BSC 20 in accordance to the invention.

For instance, a failure has occurred at source process 24, which handles call 26 and call 27. In this example, the service logic 21 detects that a failure occurred at the source process 24 (step 305). The service logic 21 then sends to the target BSC 30 a Source ID 210=1 that identifies source process 24 in an A7 reset message 335 for tearing down the calls handled by source process 24 (calls 26 and 27). At step 337, the source process 24 does not send messages related to the calls until it receives a confirmation that the calls are dropped at the target BSC 30. At step 315, the service logic 31 processes the reset message 335. The service logic 31 further sends to its target processes an indication 340 that Source ID 210=1 (source process 24) has failed and that all associated calls should be dropped (step 320). The target processes 34, 35 and 36 each accesses their memory for retrieving the calls associated with Source ID 210=1 (step 325).

At step 330, the appropriate target processes drop the calls associated with failed Source ID 210=1 (source process 24). More particularly, call 26 is dropped at the target process 34 and call 27 is dropped at target process 35. At step 340, target processes 34 and 35 send a confirmation 342 to the service logic 31 and therefore the source BSC 20 for indicating that the calls handled by the failed source process 24 have been dropped. Consequently, the target BSC 30 sends an A7 reset response 345 to the source BSC 20 for indicating that the calls have been dropped. At step 350, the service logic 21 sends a confirmation 348 to the failed source process 24 for informing the source BSC 20 that the calls handled by the source process 24 have been dropped at the target BSC 30.

Alternatively, a failure may occur at the target BSC 30. Reference is now made to FIG. 3b, which is a flow chart showing a method for clearing a call if a failure occurs at the source BSC 20 in accordance to the invention.

For instance, a failure has occurred at target process 35, which handles call 27. In this example, the service logic 31 detects that a failure occurred at the target process 35 (step 405). The service logic 31 then sends to the source BSC 20 a Target ID 225=2 that identifies target process 35 in an A7 reset message 435 for tearing down the call handled by the target process 35 (call 27). At step 437, the target process 35 does not send messages related to the calls until it receives a confirmation that the calls are dropped at the target BSC 30. At step 415, the service logic 31 processes the reset message 435. The service logic 21 further sends to its source processes an indication 440 that Target ID 225=2 (target process 35) has failed and that all associated calls should be dropped (step 420). The source processes 24 and 25 each accesses their memory for retrieving the calls associated with Target ID 225=2 (step 425).

At step 430, the appropriate source processes drop the calls associated with failed Target ID 225=2 (target process 35). More particularly, call 27 is dropped at the source process 24. At step 440, source process 25 sends a confirmation 442 to the service logic 21 and therefore the source BSC 20 for indicating that the calls handled by the failed target process 35 have been dropped. Consequently, the source BSC 20 sends an A7 reset response 445 to the target BSC 30. At step 450, the service logic 31 sends a confirmation 448 to the failed target process 35 for informing the target BSC 30 that the calls handled by the target process 35 have been dropped at the source BSC 20.

It can be understood that some messages and therefore some parameters sent from the MT 10 to the telecommunication network 100 and vice versa are not mentioned nor described for clarity reasons. Also some messages and therefore some parameters sent between network elements in the telecommunication network 100 are omitted for clarity reasons. It should also be understood that FIGS. 1-4 each depict a simplified telecommunication network 100, and that many other nodes have been omitted for clarity reasons only.

Although several preferred embodiments of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for performing a soft handoff of a mobile terminal (MT) from a source base station controller (BSC) to a target BSC in a telecommunication network, the method comprising steps of:
sending from the source BSC to the target BSC a request for handing off the MT to the target BSC, the request including a source process identifier (Source ID) for identifying a source process that handles a call for the MT in the source BSC;
assigning a target process at the target BSC for handling the call;
storing at the target BSC the Source ID and a target process identifier (Target ID), wherein the Target ID identifies the target process that handles the call for the MT in the target BSC;
sending from the target BSC to the source BSC a handoff response, the handoff response including the Target ID;
detecting a failure at one of the target BSC and the source BSC;
responsive to the detection, sending a reset message from one of the target BSC and the source BSC to one of the source BSC and the target BSC, the reset message including the Target ID if the failure is detected at the target BSC and the Source ID if the failure is detected at the source BSC; and
using one of the Source ID or the Target ID of the reset message for tearing down the call at one of the target BSC and the source BSC.

2. The method of claim 1, wherein the target BSC processes the request at the service logic of the target BSC prior to the step of assigning the target request for handling the call.

3. The method of claim 1, wherein the step of storing further includes the steps of:
associating at the target BSC the Source ID and the Target ID with the call; and
storing the Source ID and the Target ID in a memory of the target BSC.

4. The method of claim 1, wherein the step sending from the target BSC to the source BSC the response further includes the steps of:
associating at the source BSC the Source ID and the Target ID with the call;
storing the Source ID and the Target ID in a memory of the source BSC; and
establishing a path between the source process at the source BSC and the target process at the target BSC for the call.

5. A target base station controller (BSC) for handing off a mobile terminal (MT) in a telecommunication network, the BSC comprises:
a service logic for:
receiving a request message from a source BSC for handing off the MT, the request message including a source process identifier (Source ID) for identifying a source process that handles a call for the MT in the source BSC;
assigning at the target BSC at least one target process for handling the call, wherein the at least one target process comprises a memory for storing the Source ID and a target process identifier (Target ID) for identifying the at least one target process that handles the call for the MT in the target BSC; and
wherein the service logic detects a failure at the target BSC and sends to the source BSC a reset message including the Target ID for tearing down the call associated with the at the source BSC.

6. The target BSC of claim 5, wherein the service logic further sends to the source BSC a handoff response including the Target ID.

7. The target BSC of claim 5, wherein the service logic processes the received request prior to assigning a target process at the target BSC for the call.

8. The target BSC of claim 5, wherein the service logic further associates the Source ID and the Target ID with the call and stores this information in the memory.
